(19) United States
(12) Patent Application Publication
(10) Pub. No.: US 2022/0218148 A1
(43) Pub. Date: Jul. 14, 2022

(54) PORTABLE WARMER SYSTEM FOR LIQUIDS

(71) Applicant: VeeraVani Investment LLC, Bowling Green, KY (US)

(72) Inventor: Rishi Agarwal, Bowling Green, KY (US)

(21) Appl. No.: 17/548,928

(22) Filed: Dec. 13, 2021

Related U.S. Application Data
(60) Provisional application No. 63/136,290, filed on Jan. 12, 2021.

(51) Int. Cl. A47J 36/24; A47J 36/32; H05B 3/06

(52) U.S. Cl. CPC A47J 36/2433; H05B 3/06; A47J 36/32

(57) ABSTRACT

The present disclosure describes a portable liquid warmer system for warming food. The portable liquid warmer system includes a container and a heating base. The container defines a chamber to contain a liquid food or fluid and includes at least one tubular slot defined therein. The heating base includes a heating element and at least one tubular heat transfer element. The heating base is configured to receive the container such that the at least one tubular heat transfer element is received in the at least one tubular slot so that the at least one tubular heat transfer element surrounds a portion of the chamber, and the heating element is operable to heat the liquid food or fluid contained in the chamber via the at least one tubular heat transfer element.

### RELATED APPLICATION(S)

The present application claims priority to and the benefit of U.S. Provisional Application Ser. No. 63/136,290, filed Jan. 12, 2021, the disclosure of which is hereby incorporated herein in its entirety.

### FIELD

The present invention relates generally to consumer goods, and more particularly, to a portable warmer system for liquids.

### BACKGROUND

Baby bottles and other similar drinking devices are utilized to assist toddlers and babies in consuming different types of drinks and foods in a safe manner. Such devices tend to be more convenient for babies to drink from because they have a nipple that the babies can directly drink from more easily. Even though traditional baby bottles are more convenient to drink from than conventional glasses or cups, traditional baby bottles may still not offer enough convenience, safety features, or other features. As a result, companies and families have developed and used different types of heating methods and devices to try to ensure that baby bottles and other drinking devices adequately protect babies from extremes in temperature and from dangerous parts, while also offering the babies a convenient way of consuming food. There are a variety of different types of devices and methods used for regulating the temperature of food and drinks for babies. For example, heat packs, gel packs, thermal sleeves, thermoses, heat-shielding devices, and various types of baby bottles have been developed to regulate the temperature of food and drinks that babies consume.

Although these and a variety of other devices exist for regulating the temperature of food and drinks that babies consume, such devices can often be cumbersome, time consuming to set up, unsafe, and may not adequately regulate the temperature of food or drinks. For example, heat packs and gel packs may become too hot or too cold if they are microwaved, boiled, or frozen and may ultimately be too dangerous for babies. Additionally, many existing temperature regulating devices fail in keeping food or drinks at an adequate temperature for an extended duration. Finally, existing products may further include a multitude of components that may too easily cause injuries to babies.

### SUMMARY

A first aspect of the present invention is directed to a portable liquid warmer system for warming food. The system includes a container and a heating base. The container defines a chamber to contain a liquid food or fluid, the container including at least one tubular slot defined therein. The heating base includes a heating element and at least one tubular heat transfer element. The heating base is configured to receive the container such that the at least one tubular heat transfer element is received in the at least one tubular slot so that the at least one tubular heat transfer element surrounds a portion of the chamber, and the heating element is operable to heat the liquid food or fluid contained in the chamber via the at least one tubular heat transfer element.

Another aspect of the present invention is directed to a bottle warming apparatus. The apparatus includes a bottle, a bottle housing for enclosing the bottle, and a heating base. The bottle includes a first volume configured to receive and store at least one of food or fluid, and further includes one or more recessed portions in a circular position at a bottom of the bottle. An inner wall of the bottle housing defines a second volume having a size and shape for receiving at least a portion of the bottle. The heating base has a heating element with one or more cylindrical projections, the one or more cylindrical projections having a heating capacity and are configured to come into contact with an outer surface of the bottle containing the at least one of food or fluid.

Another aspect of the present invention is directed to a portable liquid food warmer system. The system includes a container and a heating base. The container having a body that includes a bottom wall and a sidewall which together define a chamber for holding a contents, the bottom wall having an outer annular recess and an inner annular recess that both project upwardly into the chamber, each annular recess having an opening at a bottom end of the container. The heating base includes a heating element and two heat transfer elements extending upwardly therefrom. The heating base is configured to receive the container such that one heat transfer element is received within the outer annular recess and the other heat transfer element is received within the inner annular recess through the annular openings and the heating element is operable to heat the contents contained in the chamber via the heat transfer elements.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a side and bottom view of a warming apparatus according to embodiments of the present invention.

FIG. 2 is a side view illustrating a container being inserted into the warming apparatus of FIG. 1 according to embodiments of the present invention.

FIG. 3 is a cross-sectional side view of the bottle and warming apparatus of FIG. 2 according to embodiments of the present invention.

FIG. 4 is a bottom view of the warming apparatus of FIG. 2 according to embodiments of the present invention.

FIG. 5 is a side view of the heating elements of the warming apparatus of FIG. 2 according to embodiments of the present invention.

FIG. 6 is a bottom perspective view of the container of FIG. 2 according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

A portable warmer apparatus and methods according to embodiments of the present invention can address the deficiencies and problems discussed above and are intended to provide a rapid heating, safe and easy to use system for heating liquids and food.

A bottle/container warming apparatus may be provided in accordance with embodiments of the present invention. The apparatus may include a bottle for storing food and fluids. The bottle may include a recessed portion and indentations on the bottom. Additionally, the apparatus may include a bottle housing unit configured to receive the bottle. The apparatus may also include a heating base with one or more heating elements that is positionable into the recessed portion of the bottle through cylindrical projections which will project into the indentations on the base of the bottle. The heating element(s) may be covered with a retractable sleeve which retracts when the bottle is pushed on it and covers the heating element when the bottle is taken out.

Furthermore, the apparatus of the present invention may include a pressure-sensitive switch that activates the apparatus when the bottle exerts enough pressure against the switch as the bottle is positioned into the bottle housing. Heat may be generated by the heating elements when the apparatus is activated and be utilized to warm the bottle. The apparatus may further include a temperature sensor for measuring a temperature of the bottle. A signal may be transmitted to instruct the apparatus to deactivate when an optimal temperature is reached. A sound signal may be attached to the sensor which will indicate that the optimal temp has been reached.

Furthermore, there may be a retractable cover on the bottle housing which will open up as you push the bottle into the heating elements and which covers itself back on taking the bottle out to prevent any damage from the heating element to the operating person.

The invention may be used with a variety of containers, such as cups, mugs, travel mugs, baby bottles beer mugs, carafes, or liquid containers, and more particularly to actively heated or cooled drinkware.

A bottle warming apparatus according to embodiments of the present invention may include a bottle, which may be utilized to hold or store food, liquids, or other contents. In one embodiment, the bottle may include a nipple and a recessed portion that may be located on the bottom of the bottle. Additionally, the bottle warming apparatus may include a bottle housing which may be a part of the base heating plate or attached separately that may include an inner wall that may define a volume that can receive at least a portion of the bottle. A heating element (e.g. a base heating plate) may also be included in the bottle warming apparatus and may be configured to position within the recessed portion of the bottle when the bottle is positioned into the bottle housing. The base heating plate may be covered with an insulating material where contact with skin or bottle is possible to prevent heating the bottle to avoid injury to the child. In some embodiments, the heating element may be covered with a retractable sleeve which retracts when the bottle is pushed on it and covers the heating element when the bottle is taken out.

In some embodiments, there may be a retractable cover on the bottle housing which will open up as a user pushes the bottle into the heating elements and which covers itself back on taking the bottle out to prevent any damage from the heating element to the operating person.

The base heating plate may be connected to a power source such as direct AC or DC current using batteries, automotive adapter (such as a cigarette lighter), and/or an AC outlet adapter.

The bottle warming apparatus of the present invention may further include a pressure-sensitive switch that may be used to turn on the bottle warming apparatus when the bottle applies enough pressure against the pressure-sensitive switch when being inserted into the housing.

In some embodiments, when the bottle warming apparatus is turned on, the heating element may generate and transmit heat to the bottle though the heating cylinders which will project into the indentations at the bottom of the container, causing the bottle to warm up.

In some embodiments, the bottle warming apparatus may also include a temperature sensor for measuring the temperature of the bottle at any given time. While the temperature sensor is monitoring and measuring the temperature, the temperature sensor may transmit a signal to the bottle warming apparatus to turn off the bottle warming apparatus when an optimal temperature is reached.

In some embodiments, a sound signal may be attached to the sensor which will indicate that the optimal temp has been reached.

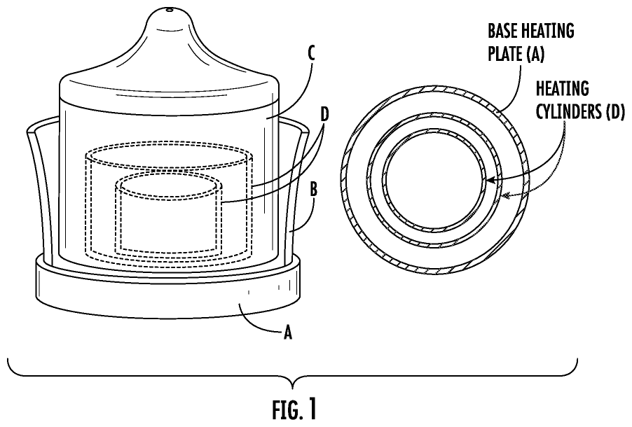

The above-described and other features and advantages of the present disclosure will be appreciated and understood by those skilled in the art from the following detailed description, drawings, and appended claims. Embodiments of the present invention will now be discussed in greater detail with reference to FIGS. 1-6.

Referring to FIG. 1, the apparatus of the present invention includes a heating base (A) which may have a heating element connected to a power source. In some embodiments, the base heating plate may be covered by an insulating material. The heating element may be attached to a cylindrical receiving unit (B) to hold the bottle or container (C) in place. One or more heating cylinders (D) are configured to project into circular indentations on the base of the bottle or any container that may require to be heated. In some embodiments, the heating cylinders may project into the base of the bottle a distance in the range of about 0 centimeters to about 10 centimeters.

A bottle warming apparatus may include a bottle, which may be utilized to hold or store food, liquids, or other contents. The bottle may include a nipple and a recessed portion that may be located on the bottom of the bottle. Additionally, the bottle warming apparatus may include a bottle housing which may be a part of the base heating plate or attached separately that may include an inner wall that may define a volume that can receive at least a portion of the bottle. A base heating plate may also be included in the bottle warming apparatus and may be configured to position within the recessed portion of the bottle when the bottle is positioned into the bottle housing. In some embodiments, the base heating plate may be covered by insulating material where contact with skin or bottle is possible to prevent heating the bottle to avoid injury to the child. The heating base may have one or more heating elements with cylindrical projections where the projections will also have heating capacity and the cylindrical projections will come in contact with the outer surface of the bottle containing the liquid. The projecting heating element may be covered with a retractable sleeve which retracts when the bottle is pushed on it and covers the heating element when the bottle is taken out.

Furthermore, in some embodiments, there may be a retractable cover on the bottle housing which will open up as a user pushes the bottle into the heating elements and which covers itself back on taking the bottle out to prevent any damage from the heating element to the operating person.

The base heating plate may be connected to a power source such as direct AC or DC current using batteries, automotive adapter (such as a cigarette lighter), and/or an AC outlet adapter.

The bottle warming apparatus of the present invention may further include a pressure-sensitive switch that may be used to turn on the bottle warming apparatus when the bottle applies enough pressure against the pressure-sensitive switch when being inserted into the housing.

In some embodiments, when the bottle warming apparatus is turned on, the heating element may generate and transmit heat to the bottle though the heating cylinders which will project into the indentations at the bottom of the container, causing the bottle to warm up.

The bottle warming apparatus of the present invention may also include a temperature sensor for measuring the temperature of the bottle at any given time. While the temperature sensor is monitoring and measuring the temperature, the temperature sensor may transmit a signal to the bottle warming apparatus to turn off the bottle warming apparatus when an optimal temperature is reached.

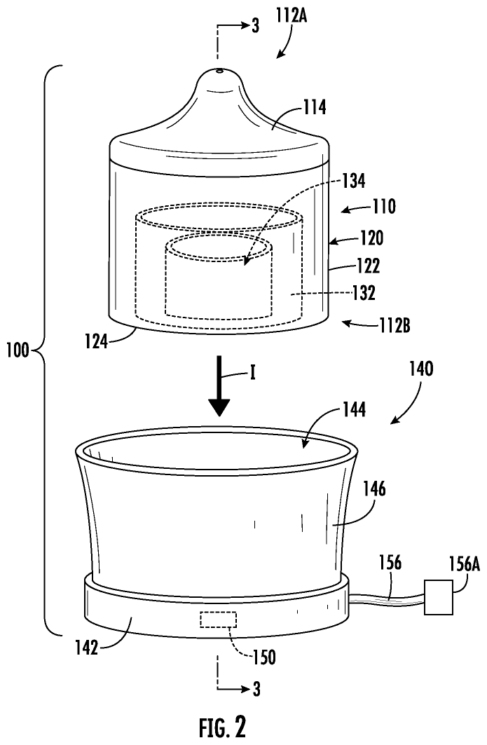

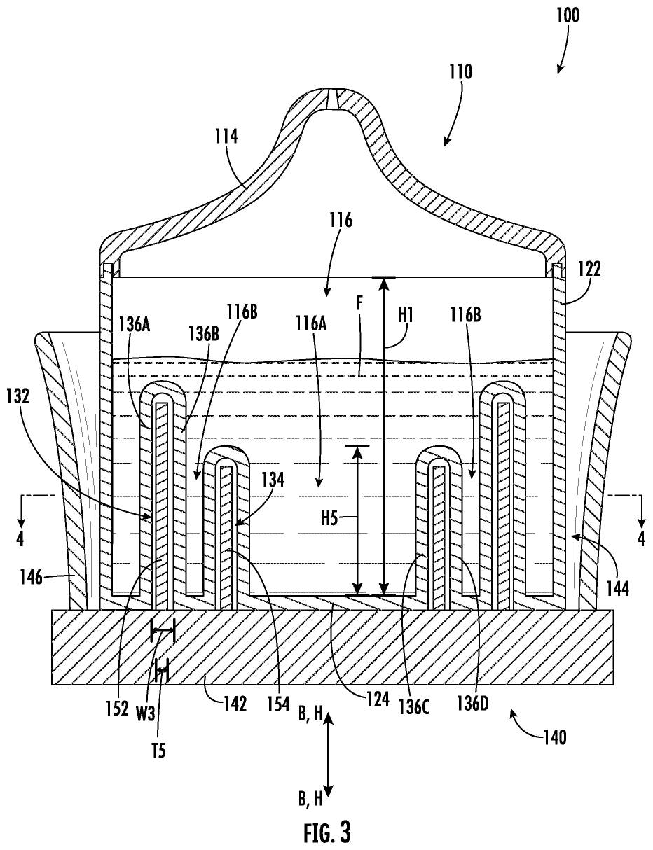

With reference to FIGS. 2-6, a portable liquid warmer system 100 for warming the contents of a container (e.g., a baby bottle) according to embodiments of the present invention is illustrated. The system 100 includes a heating base or unit 140 and a food container 110. As illustrated and referred to hereinbelow, the food container 110 is a bottle; however, the food container 110 may take other forms and uses. The bottle 110 is adapted or configured to be mounted on and cooperate with the heating base 140 to heat (i.e., transfer heat energy to) the contents F (see, e.g., FIG. 3) of the bottle 110. In some embodiments, the contents F is or includes a liquid food (e.g., milk or baby formula). In particular, the contents F may be a food being prepared for consumption by a small child (e.g., under 3 years of age). The contents F are only shown in FIG. 3.

The bottle 110 has a bottle axis B-B, an upper end 112A and an opposing bottom end 112B. The bottle 110 includes a body 120 and a cap 114 (which may include a nipple). The body 120 includes a bottom wall 124 and a sidewall 122 defining a chamber 116 for holding the contents F.

In some embodiments, the body 120 is formed of a polymeric material.

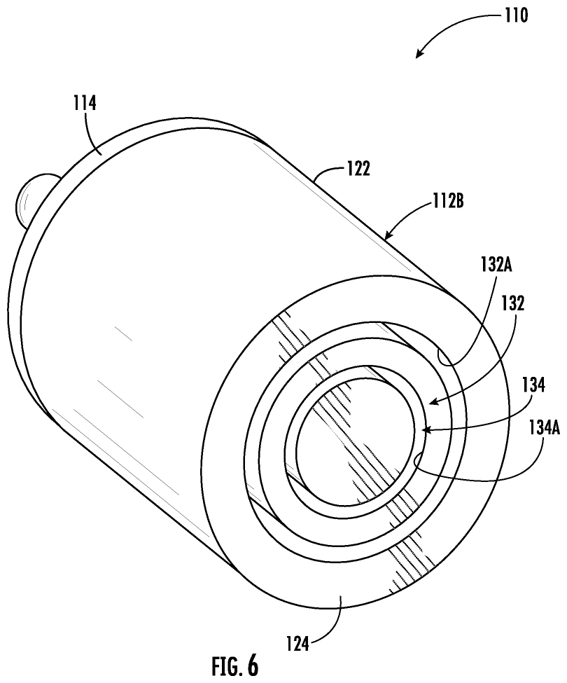

An outer receiver indentation, recess, or slot 132 and inner receiver indentation, recess, or slot 134 are each defined in the bottom wall 124. Each slot 132, 134 is defined by opposed walls 136 of the body 120 that extend into the region surrounded by the sidewall 122. Each slot 132, 134 is tubular and projects upwardly into the chamber 116 along the bottle axis B-B. Each slot 132, 134 includes an annular receiver opening 132A, 134A at the bottom end 112B (see, e.g., FIG. 6). The wall 136C defining the inner slot 134 defines a subchamber 116A that is a portion of the chamber 116. The walls 136B and 136C defining the outer slot 134 define a subchamber 116B that is a portion of the chamber 116.

In some embodiments, each slot 132, 134 is substantially cylindrical, and each receiver slot 132A, 134A is substantially circular. In some embodiments, the slots 132, 134 are concentric about the bottle axis B-B. In some embodiments, the bottle axis B-B is centrally located on the bottom wall 124.

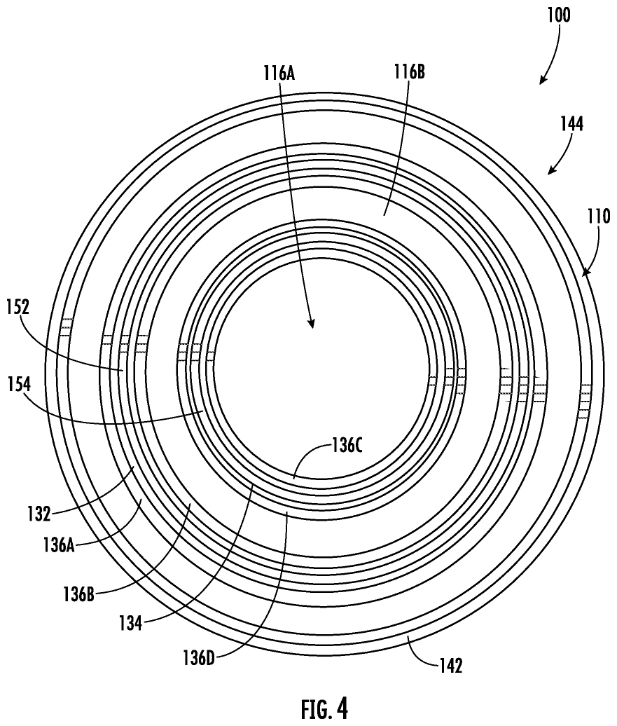

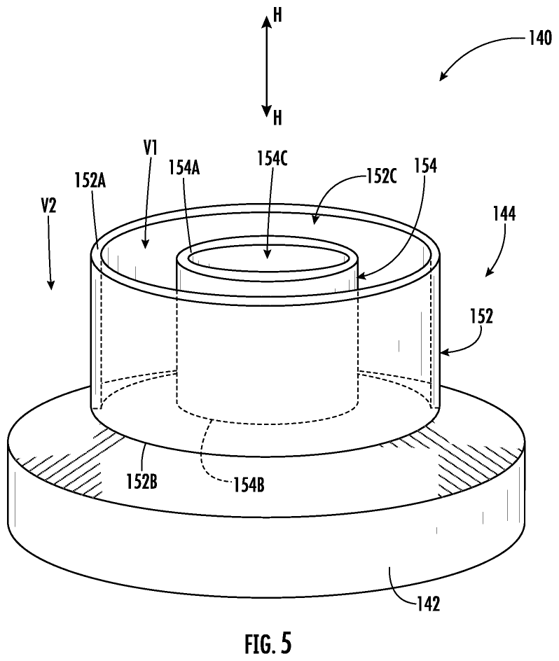

The heating base 140 has a base axis H-H. The base 140 includes a support platform 142 defining a bottle seat 144. An optional enclosure 146 (not shown in FIG. 4 and FIG. 5) surrounds the seat 144.

The base 140 also includes an electric heat generator 150, an outer heat transfer member or element 152, and an inner heat transfer member or element 154. The electric heat generator 150 may be an electrical resistance heater, for example, that generates heat from a supplied electrical current (e.g., via cord 156 and connector 156A). In some embodiments, the heat transfer elements 152, 154 are passive thermal conductors (e.g., formed of metal) and the electric heat generator 150 is mounted in the platform and thermally connected to the heat transfer elements 152, 154 to efficiently add heat energy to the heat transfer elements 152, 154. In other embodiments, one or both of the heat transfer elements 152, 154 may include integral electric heat generator elements (e.g., electrical resistors) so that the heat transfer elements 152, 154 themselves generate heat when an electrical current is supplied thereto. In some embodiments, the platform 142 itself also serves as a heat transfer element that transfers heat directly to the bottle 110 (i.e., some heat is transferred to the bottle from the platform 142 not through the heat transfer elements 152, 154). In some embodiments, the enclosure 146 also serves as a heat transfer element (e.g., may be formed of metal) that transfers heat directly to the bottle 110.

In some embodiments, the heat transfer elements 152, 154 are formed of metal.

Each heat transfer element 152, 154 extends from a lower end 152B, 154B affixed to the platform 142 to a free end 152A, 152B opposite the lower end 152B, 154B along the base axis H-H. The heat transfer elements 152 and 154 define upper openings 152C and 154C, respectively.

Each heat transfer element 152, 154 is tubular and projects upwardly from the platform 142 into the seat 144 along the base axis H-H. In some embodiments, each heat transfer element 152, 154 is substantially cylindrical. In some embodiments, the heat transfer elements 152, 154 are concentric about the base axis H-H. In some embodiments, the base axis H-H is centrally located in the seat 144.

A tubular void V1 is defined between the heat transfer elements 152, 154. A second tubular void V2 is defined between the heat transfer elements 152 and the enclosure 146.

In use, the bottle 110 is inserted into the seat 144 in a mounting or insertion direction I. The slots 132 and 134 are aligned with the heat transfer elements 152 and 154, respectively, such that the heat transfer elements 152 and 154 are axially received or inserted into the slots 132 and 134 as shown in FIG. 3 and FIG. 4. As also shown in the figures, the portions of the bottle 110 radially disposed between the heat transfer elements 152, 154 and the enclosure 146 are received in the voids V1, V2. The tubular heat transfer element 132 circumferentially surrounds the subchamber 116B. The tubular heat transfer element 134 circumferentially surrounds the subchamber 116A.

A warmer system 100 as described can provide efficient and even heating of the contents F. The tubular heat transfer elements 152 and 154 provide a relatively large and expanded total heat transfer surface area between the heat generator 150 and the contents F. The substantial circumferential extent or distribution and the substantial axial extent or distribution of the tubular heat transfer elements 152, 154 helps to ensure that the transferred heat is deposited across a relatively large and even volume of the contents F. This can both reduce the risk of hot spots in the contents F and promote efficient heat transfer.

While two heat transfer elements 152, 154 are shown in FIGS. 2-5, more than two heat transfer elements may be provided. In other embodiments, only one heat transfer element may be provided.

In some embodiments, the heat transfer elements 152, 154 substantially conform to the shapes of the corresponding slots 132, 134.

In some embodiments, the width of each slot 132, 134 is less than 5 mm greater that the thickness T5 (see, e.g., FIG. 3) of the heat transfer element 152, 154 received in the slot 132, 134. In some embodiments, the width of each slot 132, 134 is in the range of from about 1 mm to 5 mm greater that the thickness T5 (FIG. 3) of the heat transfer element 152, 154 received in the slot 132, 134.

In some embodiments, the thicknesses T5 (FIG. 3) of the heat transfer elements 152, 154 are equal to or greater than the widths W3 of the slots 132, 134 so that the heat transfer elements 152, 154 form an interference or snug fit with the inner walls 136A-D.

In some embodiments, each thickness T5 is in the range of from about 1 mm to 20 mm.

In some embodiments, each heat transfer element 152, 154 has a height H5 (FIG. 3) that is at least 10 percent of the overall height H1 of the chamber 116 and, in some embodiments, greater than 25% of the overall height H1.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A portable liquid warmer system for warming food, the system comprising:
a container defining a chamber to contain a liquid food or fluid, the container including at least one tubular slot defined therein; and
a heating base including:
a heating element; and
at least one tubular heat transfer element,
wherein the heating base is configured to receive the container such that the at least one tubular heat transfer element is received in the at least one tubular slot so that the at least one tubular heat transfer element surrounds a portion of the chamber, and
wherein the heating element is operable to heat the liquid food or fluid contained in the chamber via the at least one tubular heat transfer element.

2. The portable liquid warmer system of claim 1, wherein:
the at least one tubular slot includes a plurality of tubular slots defined in the container;
the at least one tubular heat transfer element includes a plurality of tubular heat transfer elements; and
the heating base is configured to receive the container such that each of the tubular heat transfer elements is received in a respective one of the tubular slots so that each of the tubular heat transfer elements surrounds a portion of the chamber.

3. The portable liquid warmer system of claim 1, wherein the container includes two tubular slots concentric about an axis of the container and the heating base includes two tubular heat transfer elements concentric about an axis of the base.

4. The portable liquid warmer system of claim 1, wherein the heat transfer elements substantially conform to the shapes of the corresponding slots.

5. The portable liquid warmer system of claim 1, wherein the at least one tubular slot is defined by opposed walls that extend into the chamber, the walls defining a subchamber that is a portion of the chamber.

6. A bottle warming apparatus, the apparatus comprising:
a bottle including a first volume configured to receive and store at least one of food or fluid, wherein the bottle includes one or more recessed portions in a circular position at a bottom of the bottle;
a bottle housing for enclosing the bottle, wherein an inner wall of the bottle housing defines a second volume having a size and shape for receiving at least a portion of the bottle; and
a heating base have a heating element with one or more cylindrical projections, wherein the one or more cylindrical projections have a heating capacity and are configured to come into contact with an outer surface of the bottle containing the at least one of food or fluid.

7. The bottle warming apparatus of claim 6, wherein the heating element is covered with a retractable sleeve which retracts when the bottle is pushed onto the heating element and covers the heating element when the bottle is taken off the heating element.

8. The bottle warming apparatus of claim 6, further comprising a retractable cover on the bottle housing configured to open when a user pushes the bottle onto the heating element and configured to close when a user removes the bottle from the heating element.

9. The bottle warming apparatus of claim 6, wherein the heating base is powered by battery, an electrical adapter, an automotive adapter, or a solar power source.

10. The bottle warming apparatus of claim 6, further comprising a pressure-sensitive switch within the bottle housing configured to trigger activation of the bottle warming apparatus such that the heating element generates and transmits heat to the bottle when the bottle warming apparatus is activated.

11. The bottle warming apparatus of claim 6, further comprising a temperature sensor for measuring a temperature of the bottle placed in the bottle housing and stop further heating once a predetermined temperature has been reached.

12. The bottle warming apparatus of claim 6, further comprising a light source configured to indicate when the bottle is positioned into the bottle housing and after the bottle warming apparatus is activated, and further configured to indicate when a predetermined optimal temperature has been reached.

13. The container warming apparatus of claim 6, wherein the heating base is programed to turn off once a predetermined temperature has been reached.

14. The container warming apparatus of claim 6, further comprising a sound indicator configured to notify a user when a predetermined optimal temperature has been reached.

15. A portable liquid food warmer system, the system comprising:
a container having a body that includes a bottom wall and a sidewall which together define a chamber for holding a contents, the bottom wall having an outer annular recess and an inner annular recess that both project upwardly into the chamber, each annular recess having an opening at a bottom end of the container; and
a heating base, the heating base including:
a heating element; and
two heat transfer elements extending upwardly therefrom;
wherein the heating base is configured to receive the container such that one heat transfer element is received within the outer annular recess and the other heat transfer element is received within the inner annular recess through the annular openings; and
wherein the heating element is operable to heat the contents contained in the chamber via the heat transfer elements.

16. The portable liquid food warmer system of claim 15, wherein the container is a bottle, and the contents therein is or includes a liquid food.

17. The portable liquid food warmer system of claim 15, wherein the outer and inner annular recesses are concentric.

18. The portable liquid food warmer system of claim 15, wherein the heating base further includes a support platform defining a bottle seat and an enclosure that surrounds the bottle seat.

19. The portable liquid warmer system of claim 18, wherein a first tubular void is defined between the heat transfer elements and a second tubular void is defined between the heat transfer elements and the enclosure.

20. The portable liquid food warmer system of claim 15, wherein the outer and inner recesses in the container are configured to align with the heat transfer elements such that each heat transfer elements is axially received by a respective recess.
